(19) United States
(12) Patent Application Publication
(10) Pub. No.: US 2008/0056799 A1
(43) Pub. Date: Mar. 6, 2008

(54) Sheet retaining structure and printer for an electronic voting device

(76) Inventors: Shinji Nureki, Chiba-shi (JP); Makoto Matsuda, Chiba-shi (JP); Tomohiko Hoshida, Chiba-shi (JP); Takumi Seino, Chiba-shi (JP)

Correspondence Address: BRUCE L. ADAMS, ESQ., SUITE 1231, 17 BATTERY PLACE, NEW YORK, NY, 10004, US

(21) Appl. No.: 11/879,880

(22) Filed: Jul. 19, 2007

(30) Foreign Application Priority Data
Aug. 31, 2006 (JP) 2006-235490

(51) Int. Cl. B41J 11/66

(52) U.S. Cl. 400/613.2

(57) ABSTRACT

In order to provide a printer for an electronic voting device, capable of smoothly transporting a recording sheet having a free end and capable of realizing downsizing and simplification, a container (7) includes a main body portion (7d) mounted on to a casing (6a) of a printer (6) and a movable portion (7e) attached to the main body portion (7d) so as to be capable of being opened and closed. In a state where the container (7) is opened, a fanfold sheet (16) in a state where a deflection thereof is small is inserted as it is, and the movable portion (7e) is then closed with respect to the main body portion (7d). As a result, the fanfold sheet (16) is retained in the container (7) in a state where the fanfold sheet (16) is largely deflected in a U-shape. The fanfold sheet (16) can smoothly be supplied from the container (7) into the casing (6a) The printer (6) prints electronic voting contents on the fanfold sheet (16) which is smoothly supplied. When the printed content is visually confirmed, the printer (6) prints characters indicating approval thereof. After that, a printed portion of the fanfold sheet (16) is cut off to be discharged.

### BACKGROUND OF THE INVENTION

1. Field of the Invention

The present invention relates to a sheet retaining structure and a printer for an electronic voting device including the same.

2. Description of the Related Art

Conventional election in municipalities or the like has been performed in such a manner that voters write person's name or the like on voting sheets and put the voting sheets in a ballot box. Vote counting is performed in such a manner that the ballot box is opened in the presence of an election official, the voting sheets are taken out and, the voting sheets are visually read one by one and summed up. In this manner, the conventional election is performed completely manually. Therefore, it takes time for summation and confirmation of results of the vote counting, and effort of operators is enormous.

Here, in recent years, electronic voting using computers begins to be adopted. A basic structure of an electronic voting system includes electronic voting terminals arranged in voting booths, respectively, and a server connected to the electronic voting terminals. Each of the electronic voting terminals includes a display device (display) for displaying names of candidates or the like, and an input device for allowing the voter to vote therethrough. There may also be a case where there is used a touch panel in which the display device is integrated with the input device.

In the electronic voting, by summing up electronic data (voting contents) inputted through the input device of each of the electronic voting terminals in the server, the vote counting is performed. However, in order to confirm whether there is no fraud or tampering in the voting, it is desired to perform an audit. In order to perform the audit, it is necessary not only to store the voting contents as the electronic data but also to print the voting contents by a printer, thereby making it possible to store the voting contents as printed medium. That is, it is necessary to include a printer connected to the electronic voting terminals.

Patent Documents 1 (JP 2002-230610 A) and 2 (JP 2002-279126 A) disclose an electronic voting device in which a printer is connected to an electronic voting terminal and printed results of the printer can be visually confirmed in a voting booth. According to this structure, a voting content inputted by a voter through an input device is not only transmitted to a server as electronic data but also printed on a sheet by the printer. The voter can confirm the voting content by viewing the printed results on the sheet through a window portion.

In an electronic voting device, it is assumed that an indefinite number of voters vote without a break, so it is desirable that occurrence of running out of a sheet of a printer connected to an electronic voting terminal be avoided as much as possible. Accordingly, Patent Documents 1 and 2 adopt a structure in which printing is performed on a long rolled sheet, and after a printed content (voting content) is confirmed by the voter, the printed portion is successively reeled in a roll form. However, by using such a reel system, voting results are printed in an order of the voting. Therefore, by viewing the rolled sheet which is reeled, the voting content can be known according to the order of the voters, thereby causing a problem from a perspective of privacy. Further, a portion on which the voting content of the preceding voter is printed has to be prevented from being viewed by the next voter, so it is necessary to transport the printed portion to an outside of a window portion.

Here, it is conceived to successively cut the rolled sheet after printing. In this case, it suffices that recording sheets which have been cut off are collected. The plurality of collected recording sheets are scattered to some degree, and are taken out relatively randomly. Accordingly, the problem with the privacy is solved. Further, the portion on which the voting content of the preceding voter is printed is collected by being cut off from the rolled sheet, so the voting content of the preceding voter is not viewed by the next voter.

However, as described above, with the structure in which the rolled sheet is used, and the rolled sheet is cut after the printing, there are required a number of transport rollers for transporting the rolled sheet. As described above, with the structure with which the voter can view the printed results through the window portion, it is desirable that the window portion be provided between a printing portion of the printer and a discharge portion for the rolled sheet, and the window portion be made to be large in order that the printed results are easily viewed. The rolled sheet is retained in a roll form, thereby causing curling. Further, a leading end thereof is a free end, so it is difficult to smoothly transport the rolled sheet for a long distance in the window portion. Thus, it is necessary to provide the plurality of transport rollers in the window portion, thereby resulting in complication and increase in size and costs of the structure of the electronic voting device including the printer.

### SUMMARY OF THE INVENTION

Accordingly, it is an object of the present invention to provide a sheet retaining structure and a printer for an electronic voting device including the sheet retaining structure capable of smoothly transport a recording sheet having a leading end which is a free end only by using a relatively small number of transport rollers, and capable of downsizing and simplifying a structure.

A sheet retaining structure, according to the present invention is characterized by including a container for retaining a fanfold sheet stacked by alternately folding for a predetermined length, and supplying the fanfold sheet to a casing of a printer, and in that: the container includes a plurality of portions connected to each other so as to be opened and closed with respect to each other; and when the plurality of portions are in an opened state with respect to each other, the fanfold sheet can be inserted into the container, and when the plurality of portions are in a closed state with respect to each other, the plurality of portions form a concave shape extending along a longitudinal direction of the fanfold sheet, and the container can retain the fanfold sheet along the concave shape of the container in a state where the fanfold sheet is deflected to a larger degree than when in the opened state. It is preferable that the fanfold sheet be retained while being deflected in a U-shape in the container in the closed state.

According to the sheet retaining structure, in the state where the container is closed, the own weight of the fanfold sheet is mainly applied to a large-area flat surface (main surface) on which printing can be performed instead of a folded end portion or a thin side end surface. Therefore, the fanfold sheet is supported without being bent or fallen due to its own weight in the container, and a transport load is not increased due to the own weight. Thus, it is possible to smoothly feed the fanfold sheet from beginning to end. In addition, according to the sheet retaining structure, the fanfold sheet in a stacked state is arranged on a concave bottom surface of the container in the closed state, and an upper layer portion of the stacked fanfold sheet is bent inwardly as compared to a lower layer portion. Accordingly, even when an attitude of the container fluctuates, the own weight is not applied to the upper layer portion of the fanfold sheet to be drawn out at a time of sheet feeding, and the fanfold sheet is easily drawn out. Further, there is exerted a force allowing the fanfold sheet, which is bent inwardly, to unfold outwardly so as to recover from the bent state, and a part of the force acts against the own weight, so the transport load due to the own weight of the fanfold sheet is alleviated, and the fanfold sheet can be fed relatively smoothly from beginning to end. Further, it is possible to reduce a space occupied by the container in the longitudinal direction of the fanfold sheet to be small, so downsizing of the printer is not interfered to a large degree.

Further, according to the present invention, in the container in the opened state, the fanfold sheet deflected to a small degree can be inserted as it is, so an operation is extremely easy.

The plurality of portions may be connected to each other so as to be capable of being opened and closed through a hinge mechanism. In this case, by using the hinge mechanism, the container is closed, that is, the opened state is transferred to the closed state, thereby making it possible to easily allow the fanfold sheet to be in a bent state.

Note that, when one of the plurality of portions is a main body portion which can be mounted onto the casing, and the other portions are movable portions which can be opened and closed with respect to the main body portion, the casing of the printer and the container can be treated as a single unit. Therefore, attachment and detachment of the portions to and from the other members of the printer, and a maintenance operation can be easily performed.

A printer for an electronic voting device according to the present invention includes: the sheet retaining structure described above; a printing portion, arranged in the casing, for performing printing on a part of the fanfold sheet supplied from the container; a cutter portion, arranged in the casing, for cutting off the part of the fanfold sheet, on which the printing is performed by the printing portion; a window portion, provided to a portion of the casing on a downstream side of the printing portion with respect to an advancing direction of the fanfold sheet, for allowing visual recognition of the part, on which the printing is performed, from an outside; and a discharge port, provided to a portion of the casing on the downstream side of the window portion with respect to the advancing direction of the fanfold sheet, for discharging the portion on which the printing is performed and which is cut off by the cutter portion.

In the printer, the fanfold sheet which is not curled unlike the rolled sheet is used as the recording sheet, so even when the leading end is the free end, the recording sheet can be allowed to smoothly advance for a long distance. Accordingly, even when, in order to facilitate visual recognition, the window portion is formed to be relatively large, a transporting mechanism (such as transport roller) for the recording sheet is not required in the window portion, so downsizing and thinning of the printer, and simplification of the structure thereof can be attained.

According to the present invention, the fanfold sheet is used as the recording sheet, so the sheet is not curled unlike the rolled sheet. Accordingly, even in the case where the leading end is the free end, the recording sheet can smoothly advance for a long distance. As a result, in the window portion enabling visual recognition of the printed results from the outside, it is not required to provide the transporting mechanism such as a roller for supporting and transporting the recording sheet, so downsizing and thinning of the printer, and simplification of the structure thereof can be attained.

Further, according to the present invention, it is possible to suppress increase in transport load due to the own weight of the fanfold sheet. In particular, in the upper layer portion of the fanfold sheet to be drawn out to the outside of the container, the transport load due to its own weight is alleviated, so the fanfold sheet can be relatively smoothly drawn out from beginning to end. Moreover, it is possible to reduce a space occupied by the container in the longitudinal direction of the fanfold sheet to be small.

Further, in the present invention, an operation of inserting the fanfold sheet into the container is extremely easily performed, and in the container, such a state can be easily transferred to a state where the fanfold sheet is retained while being deflected to a larger degree.

### BRIEF DESCRIPTION OF THE DRAWINGS

In the accompanying drawings:

FIG. 1 is a block diagram showing an example of an electronic voting system including an electronic voting device according to the present invention;

FIG. 2 is a perspective view showing an example of a main portion of the electronic voting device shown in FIG. 1;

FIG. 3A is a side view showing an example of a main portion of a printer for the electronic voting device according to a first embodiment of the present invention; FIG. 3B is a front view thereof; FIG. 3C is a plan view thereof; and FIG. 3D is a bottom view thereof;

FIG. 4 is a vertical sectional view of FIG. 3A;

FIG. 5 is a perspective view showing a state where a container of the printer for the electronic voting device shown in FIGS. 3A-3D and 4 is closed;

FIG. 6 is a perspective view showing a state where, when the container of the printer for the electronic voting device shown in FIGS. 3A-3D and 4 is closed, a fanfold sheet is retained;

FIG. 7 is a perspective view showing a state where the container of the printer for the electronic voting device shown in FIGS. 3A-3D and 4 is opened;

FIG. 8 is a perspective view showing a state where, when the container of the printer for the electronic voting device shown in FIGS. 3A-3D and 4 is opened, the fanfold sheet is inserted;

FIG. 9 is a flow cart showing an example of an electronic voting method according to the electronic voting system shown in FIG. 1;

FIG. 10A is a schematic diagram showing a state where, when a container of a printer for an electronic voting device according to a second embodiment of the present invention is opened, a fanfold sheet is inserted; FIG. 10B is a schematic view showing a state where, when the container is closed, the fanfold sheet is retained, and FIG. 10C is a schematic view showing a state where the container is mounted to a casing;

FIG. 11A is a schematic diagram showing a state where, when a container of a printer for an electronic voting device according to a third embodiment of the present invention is opened, a fanfold sheet is inserted; FIG. 11B is a schematic view showing a state where, when the container is closed, the fanfold sheet is retained; and FIG. 11C is a schematic view showing a state where the container is mounted to a casing; and

FIG. 12A is a schematic diagram showing a state where a container of a printer for an electronic voting device according to a fourth embodiment of the present invention is opened; FIG. 12B is a schematic diagram showing a state where, when the container is opened, a fanfold sheet is inserted; and FIG. 12C is a schematic diagram showing a state where, when the container is closed, the fanfold sheet is retained.

### DETAILED DESCRIPTION OF THE PREFERRED EMBODIMENT

Hereinafter, a description will be made of an embodiment of the present invention with reference to the drawings.

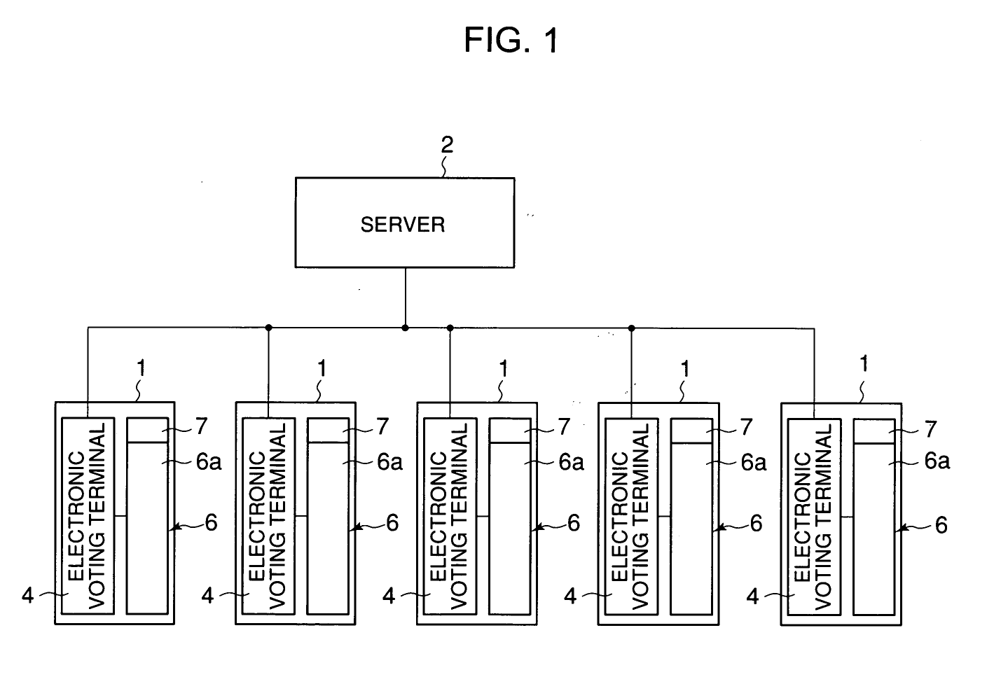

In FIG. 1, an overall structural example of an electronic voting system including an electronic voting device 1 of an embodiment of the present invention is schematically shown. The electronic voting system has a structure in which the plurality of electronic voting devices 1 (although only five of those are shown in FIG. 1) are connected to a server 2.

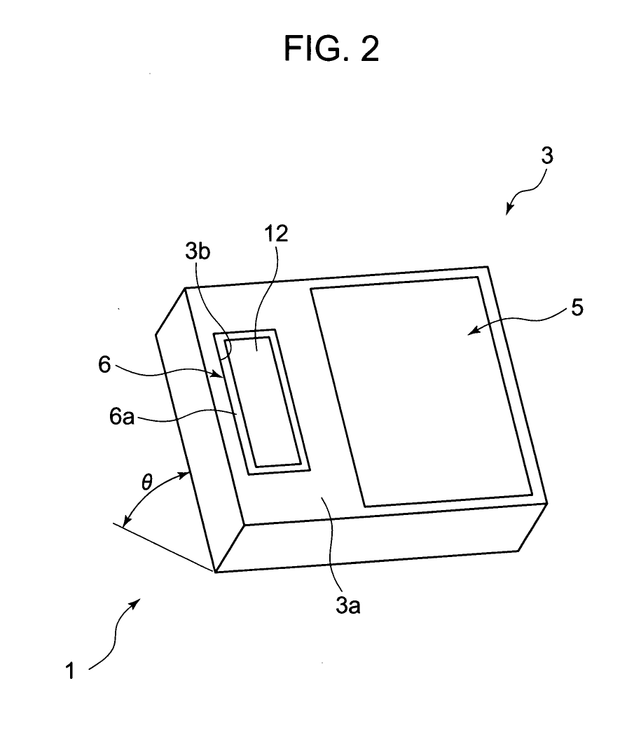

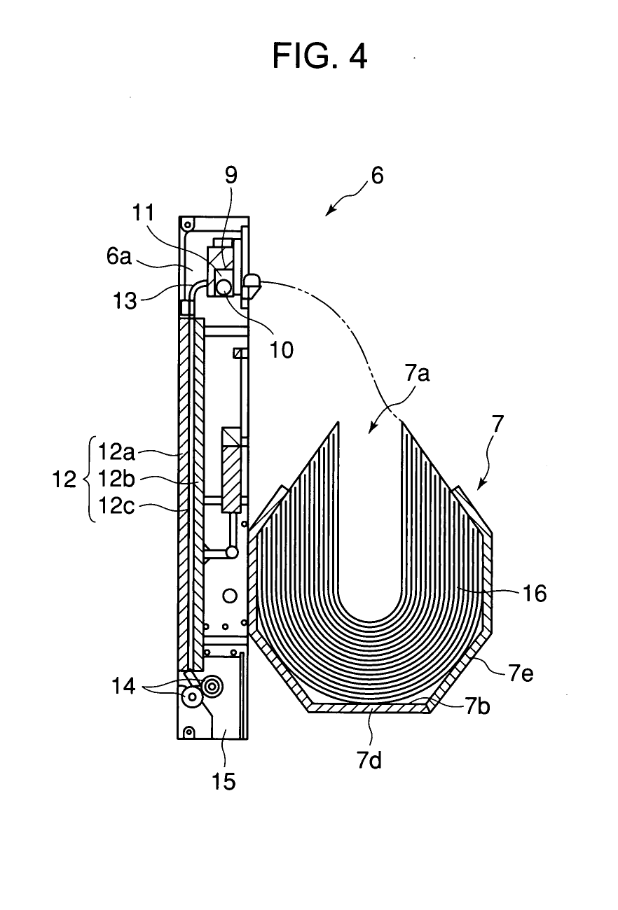

As shown in FIG. 2, the electronic voting device 1 constitutes a voting booth 3 having a base surface 3a, for example. In the electronic voting device 1, there is arranged a touch panel 5 serving as both a display device and an input device for an electronic voting terminal 4 (see FIG. 1). The touch panel 5 has a structure in which, for example, a plurality of options (e.g., a plurality of names of candidates) are displayed on a display portion (display device), and by touching an input switch (input device) in a position corresponding to each of the options (e.g., each of the names of the candidates) displayed on the display portion, inputting of a voting content is performed. Note that, in order to prevent the voting content input through the touch panel 5 from being viewed by another person, it is preferable that a blocking member be provided around the voting booth 3. Further, onto a side of the touch panel 5, a printer 6 for the electronic voting device is mounted. A casing 6a of the printer 6 is provided with a window portion 12 in a position allowing exposure through a hole portion 3b of the base surface 3a. The printer 6 will be described later in detail, but as shown in FIG. 2 and 4, there are provided a container 7 for retaining, as recording sheet, a fanfold sheet 16 (schematically shown) stacked while being alternately folded for each predetermined length, and a printing portion and a cutter portion 11 which are provided in the casing 6a.

In the electronic voting device 1, by a swing mechanism (not shown), an angle θ of the voting booth 3 including the printer 6 as a whole can be adjusted. This is performed, in consideration to a handicapped voter and voters of various heights, for freely moving and retaining the touch panel 5 to and at an attitude with which an operation is easily performed.

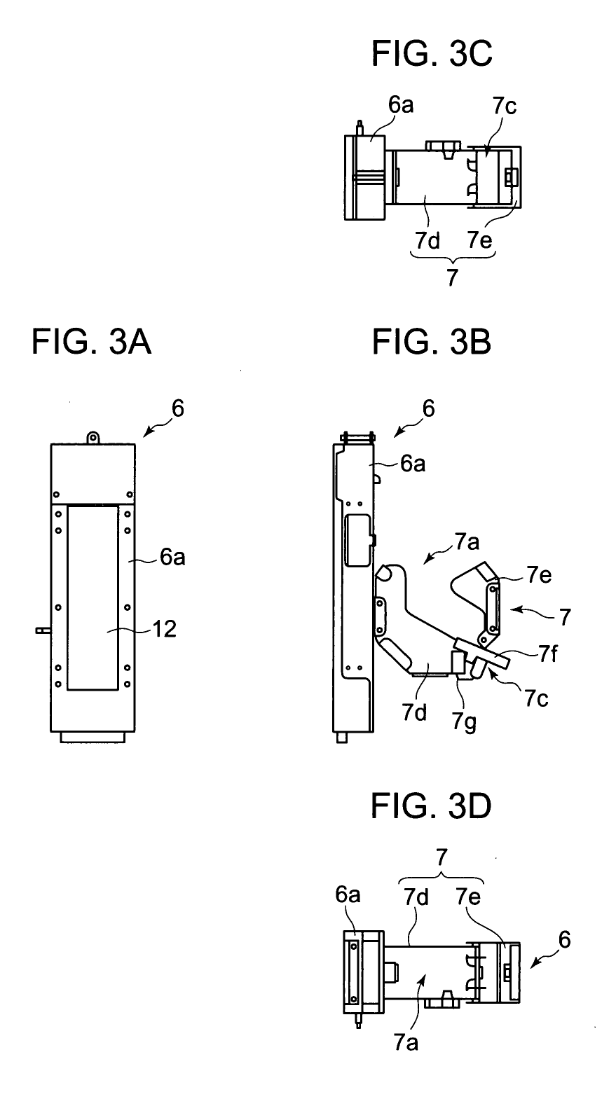

Next, the printer 6of the electronic voting device 1 according to this embodiment as shown in FIGS. 3A-3D to 8 will be described in detail. The printer 6 has the casing 6a attached to the base surface 3a of the voting booth 3. The window portion 12 is provided to a surface of the casing 6a, which is exposed to the voting booth 3. The container 7 is attached to a surface opposite to the surface with the window portion 12 of the casing 6a.

A structure inside the casing 6a of the printer 6 is shown in FIG. 4. In the casing 6a, a recording head (e.g., thermal head) 9 for performing printing on the fanfold sheet 16 is provided. The recording head 9 is positioned in an upper portion when the printer 6 is mounted onto the voting booth 3. Further, there is provided a platen roller 10, which is arranged so as to be opposed to the recording head 9, for transporting the fanfold sheet 16 while the recording head 9 presses thereon the fanfold sheet 16. Here, a portion provided with the recording head 9 and the platen roller 10 is referred to as the printing portion.

On a downstream side of the printing portion with respect to a transport direction of the fanfold sheet 16, there is provided the cutter portion 11 capable of cutting the fanfold sheet 16. For the cutter portion 11, various known structures can be adopted, so a detailed description thereof will not be made here. However, for example, there may be adopted a structure in which a stationary blade and a movable blade are arranged so as to oppose each other, and the movable blade moves toward the stationary blade, thereby cutting the fanfold sheet 16.

On the downstream side of the printing portion with respect to the transport direction of the fanfold sheet 16, there is provided a guide 13 for guiding the fanfold sheet 16 which has passed the printing portion and the cutter portion 11. The fanfold sheet 16 guided by the guide 13 is introduced to the window portion 12. The window portion 12 has a structure in which a transparent plate 12a made of a synthetic resin (e.g., polycarbonate, an ABS resin, or acrylic) and arranged on a surface exposed to the voting booth 3 and an opposed plate 12b which is not necessarily transparent are opposed to each other through intermediation of a slight clearance 12c. Accordingly, when the fanfold sheet 16 introduced by the guide 13 passes through the clearance 12c between the transparent plate 12a and the opposed plate 12b, a portion of the fanfold sheet 16, on which printing has been performed by the recording head 9, can be viewed from an outside of the casing 6a, that is, in a case where the printer 6 is mounted onto the base surface 3a, from an inside of the voting booth 3. Note that, in a region of the window portion 12, there is provided no transporting mechanism such as a roller, for transporting the fanfold sheet 16. On the downstream side of the printing portion with respect to the transport direction of the fanfold sheet 16, there are provided a discharge roller 14 and a discharge port 15 for discharging the fanfold sheet 16.

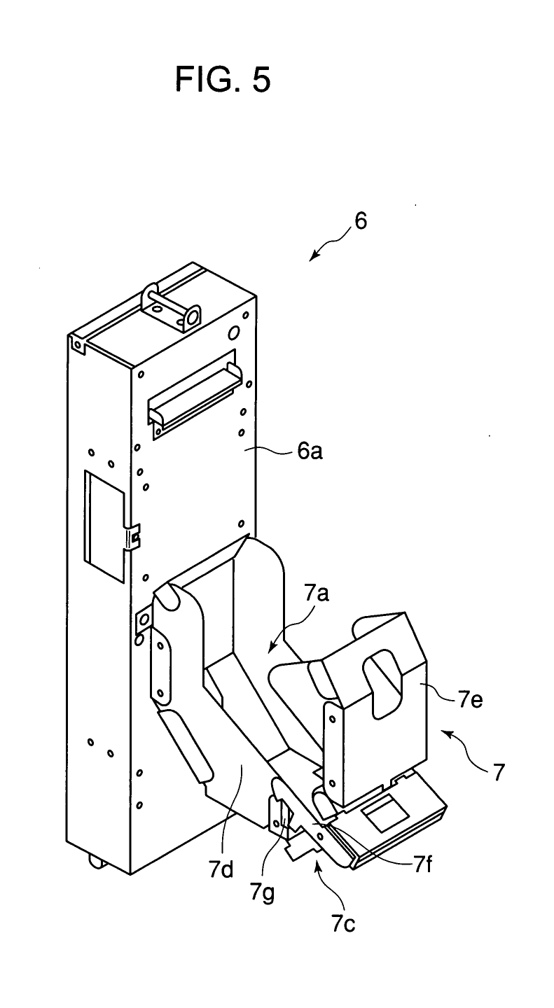

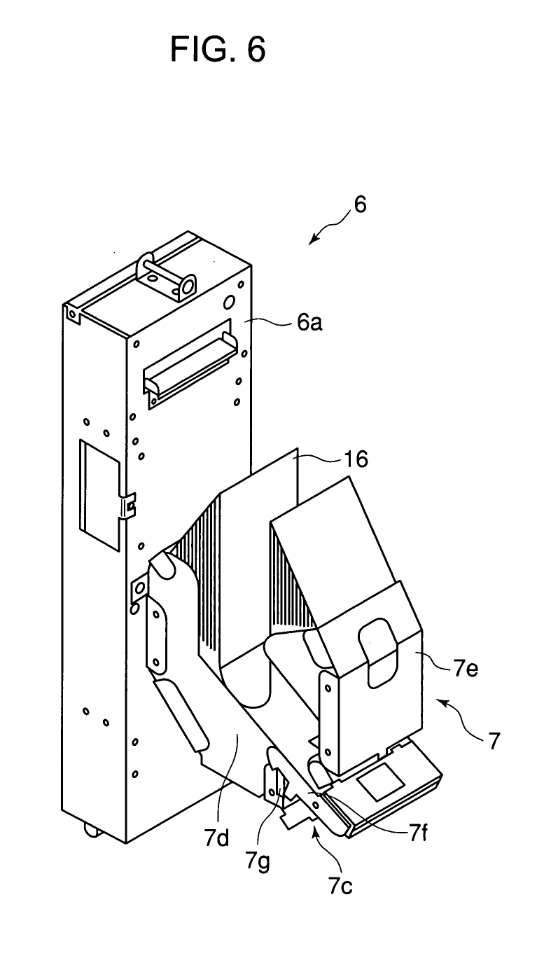

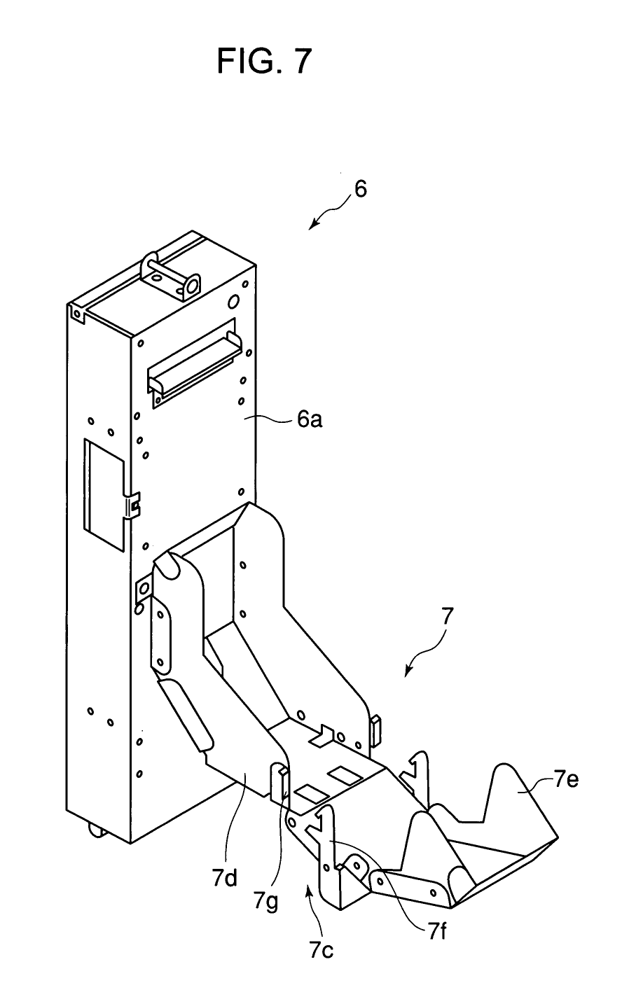

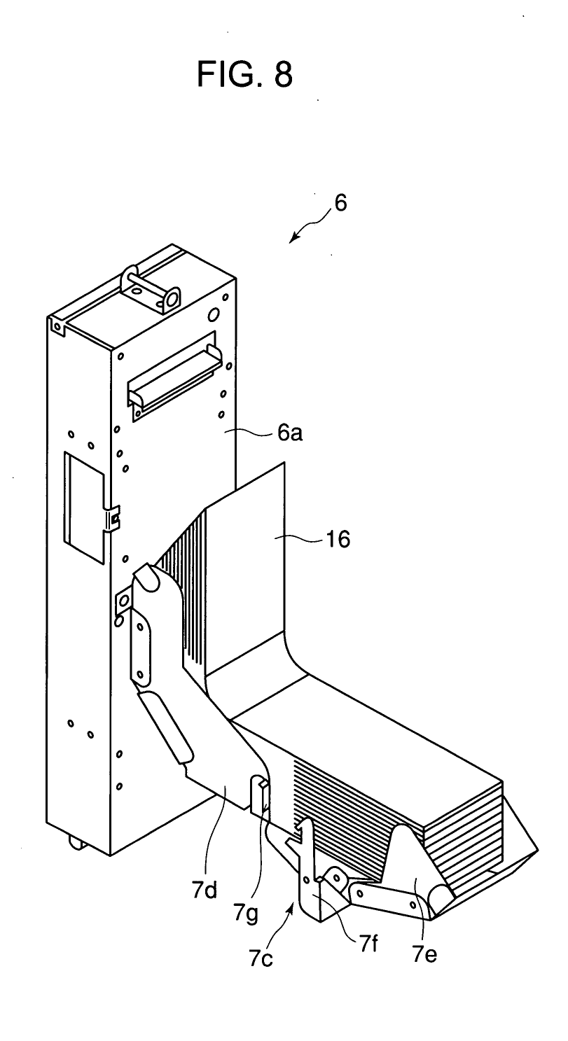

The container 7 has an accommodating portion 7a capable of accommodating the fanfold sheet 16, and is attached to the surface opposite to the surface with the window portion 12 of the casing 6a of the printer 6. The container 7 includes a pair of portions 7d and 7e connected to each other by a hinge mechanism 7c. In this embodiment, one of the portions is the main body portion 7d mounted to the casing 6a, and the other of the portions is the movable portion 7e connected to the main body portion 7d through the intermediation of the hinge mechanism 7c so as to be capable of opening and closing. The hinge mechanism 7c is attached with a lock mechanism composed of a swing arm 7f and a lock portion 7g. Accordingly, by allowing a claw-like portion at a tip of the swing arm 7f to be engaged with the lock portion 7g, as shown in FIGS. 5 and 6, there can be retained a state where the movable portion 7e is closed with respect to the main body portion 7d. Further, the claw-like portion at the tip of the swing arm 7f is spaced apart from the lock portion 7g, thereby canceling a locking state. As a result, as shown in FIGS. 7 and 8, a state where the movable portion 7e is opened with respect to the main body portion 7d can be realized.

As shown in FIG. 4, in the state where the movable member 7e is closed, a bottom surface 7b. of the accommodating portion 7a is formed in a concave shape with respect to a longitudinal direction of the fanfold sheet 16 accommodated therein. To be specific, a bottom surface of the main body portion 7d and a bottom surface of the movable portion 7e are continuous with each other, thereby constituting the concave bottom surface 7d. Accordingly, the fanfold sheet 16 is placed on the concave bottom surface 7b while being bent. Note that, irrespective of an attitude of the printer 6 at a time of use, the bottom surface 7b of the container 7 in this specification refers to a surface positioned on an opposite side of an uppermost layer portion of the fanfold sheet 16 drawn out at a time of sheet feeding, that is, a surface coming into contact with a large-area flat surface (main surface) of a lowermost layer of the stacked fanfold sheet 16, for supporting the fanfold sheet 16 (see FIG. 4). In other words, the bottom surface 7b is an inner surface of the container 7 which, normally mainly receives own weight of the fanfold sheet 16 when the fanfold sheet 16 is put into the container 7. Note that, the concave shape of the bottom surface 7b of the accommodating portion 7a of the container 7 may be changed to various shapes such as a substantially U shape, a shape obtained by dividing an ellipse in halves, and a shape obtained by dividing polygon (e.g., hexagon or octagon) in halves as long as the shape is concave.

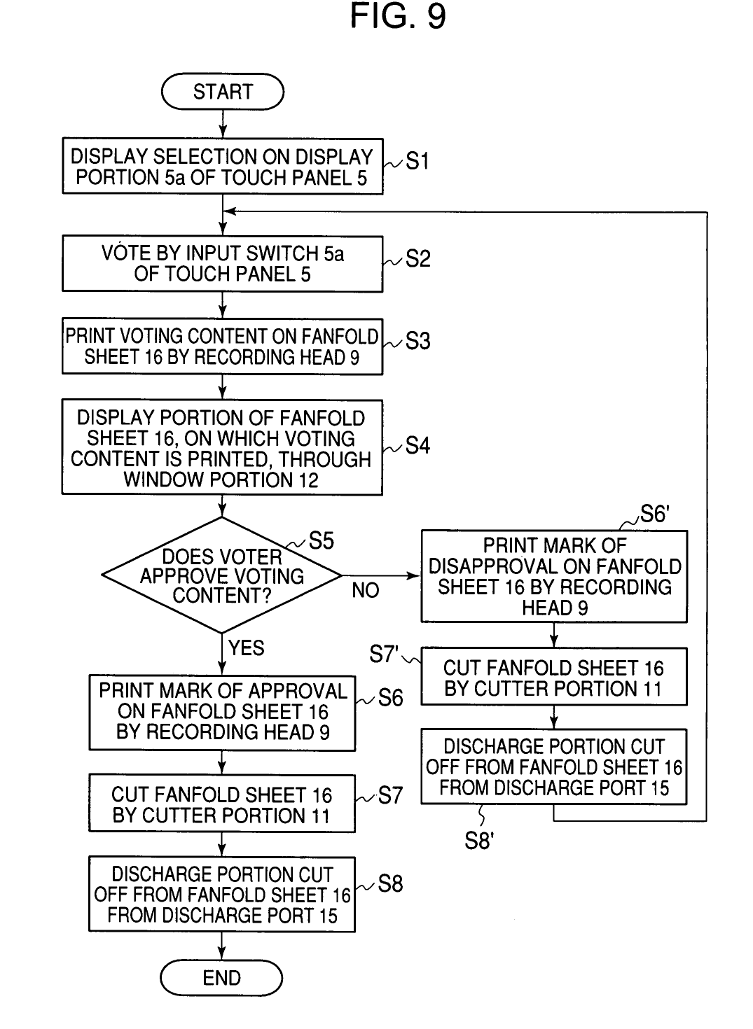

A description will be made of an example of a method of voting by using the electronic voting device 1 having the above-mentioned structure with reference to a flow chart of FIG. 9. Note that, at a time of voting as described above, the container 7 of the printer 6 is kept in the closed state (see FIGS. 4 and 6). The container 7 is kept in the opened state mainly at a time of setting the fanfold sheet 16. A detailed description thereof will be made later.

On the touch panel 5 of the electronic voting device 1 shown in FIG. 2, the plurality of options as objects of the vote, for example, the plurality of names of the candidates are displayed (Step S1). Here, the voter selects one of the options displayed on the display portion of the touch panel 5 and touches the input switch corresponding thereto (Step S2). The electronic voting terminal 4 then transmits data indicating an input content, that is, the selected option to the printer 6.

A leading end of the fanfold sheet 16 accommodated in the accommodating portion 7a of the container 7 is drawn out and set to the printing portion of the printer 6 in advance (see a chain double-dashed arrow of FIG. 4). Here, when the data indicating the selected option is transmitted from the electronic voting terminal 4 as the data to be printed as described above, the recording head 9 of the printer 6 prints the content of the selected option (e.g., the name of the selected candidate) on one of the surfaces of the fanfold sheet 16 (Step S3). The platen roller 10 then transports the fanfold sheet 16, and the fanfold sheet 16 is guided by the guide 13 to be introduced to the window portion 12. When a portion of the fanfold sheet 16 on which printing is performed by the recording head 9 reaches the clearance 12c of the window portion 12, the transportation of the fanfold sheet 16 by the platen roller 10 is temporarily stopped. In this state, the printed content (e.g., the name of the selected candidate) is displayed so that the printed content can be viewed by the voter in the voting booth 3 through the transparent plate 12a and the hole portion 3b (Step S4).

When the voter in the voting booth 3 views, confirms, and approves the printed content (e.g., the name of the selected candidate) through the window portion 12 and the hole portion 3b, in order to declare intention of determining the voting content, the voter performs an appropriate operation on an input portion of the touch panel 5 (Step S5). When the input is detected, the electronic voting terminal 4 transmits an instruction of printing indicating the determination of the voting content to the printer 6. The recording head 9 of the printer 6 prints, on a portion following a printed portion of the fanfold sheet 16, characters or a symbol indicating a meaning of determination of the voting content, such as “o” or “OK”, and a symbol indicating the voting content, for example, a bar-code (Step S6). The cutter portion 11 then cuts the fanfold sheet 16 (Step S7). At this time, the portion on which the selected content (e.g., the name of the selected candidate) is printed and the portion on which the characters or the symbol, and the bar-cord indicating the meaning of the determination of the voting content are printed are cut from the fanfold sheet 16 to be a single-cut sheet and conveyed by the discharge roller 14 to be discharged from the discharge port 15 (Step S8).

On the other hand, for example, in cases where there is a failure in the input operation, or the voter wants to change the voting content, in Step S5, in order for to desire to change the input without confirming accepting the printed content, the voter performs an appropriate operation on the input portion of the touch panel 5. When the operation for the disapproval (desire for the change) is detected, the electronic voting terminal 4 transmits the instruction of printing indicating the disapproval of the voting content to the printer 6. The recording head 9 of the printer 6 then prints, on the portion following the printed portion of the fanfold sheet 16, characters or a symbol indicating a meaning of disapproval of the voting content, such as “x” or “NG” (Step S6′). The cutter portion 11 then cuts the fanfold sheet 16 (Step S7′). The portion on which the disapproved content and the characters or the symbol indicating the meaning of the disapproval of the voting content are printed is cut from the fanfold sheet 16 to be a single-cut sheet and conveyed by the discharge roller 14 to be discharged from the discharge port 15 (Step S8′). The voting by the voter (Step S2), the printing by the printer 6 (Step S3), and the display of the printed content (Step S4) are then performed. After that, when the voting content is approved in Step S5, the recording head 9 of the printer 6 prints, on the portion following the printed portion of the fanfold sheet 16, the characters or the symbol indicating the meaning of determination of the voting content, such as “o” or “OK”, and the symbol indicating the voting content, for example, the bar-code (Step S6). The cutter portion 11 then cuts the fanfold sheet 16 (Step S7) to obtain a single-cut sheet, which is conveyed by the discharge roller 14 and discharged from the discharge port 15 (Step S8).

When the vote regarding one voter is completed through the above mentioned Steps S1 to S8, the state enters a standby state ready for vote by a next voter. At this time, the leading edge of the fanfold sheet 16 is positioned in the cutter portion 11, and does not exist in the window portion 12. The portion on which the content of the vote by the preceding voter is printed is cut off by the cutter portion 11, as described above. Therefore, as a matter of course, the portion is not viewed by the next voter. The voting operation described above (Steps S1 to S8) is performed by the next voter.

When the voting operation is repeated by the plurality of electronic voting devices 1 and the voting content is transmitted at an arbitrary timing from the electronic voting devices 1 to a server as electronic data, in the server 2, the plurality of voting contents are stored as electronic data, and at the same time, in each of the electronic voting devices 1, the plurality of recording sheets each having a single-cut sheet shape on which the voting content is printed are accommodated. When votes by all qualified voters are completed or a predetermined voting time is up, the voting is closed. The server 2 then sums up the voting contents transmitted by the electronic voting devices 1. Alternatively, as in a conventional case, it is also possible for an operator to manually take out, read, and sum up the accommodated recording sheets each having the single-cut sheet shape. The latter summing up operation can be employed for validation as backup of the electronic summing up by the server 2. This may be performed for all the electronic voting devices 1 as required. However, this may be performed only for a part of the electronic voting devices 1. Alternatively, this may be performed only in a case where there arises some problem at the time of vote counting by the server 2.

In this embodiment, for performing the electronic voting, after the voter operates the input portion of the touch panel 5 to perform the input, the fanfold sheet 16 on which the voting content thereof is printed can be visually confirmed through the window portion 12. The voting content finally approved by the voter is sent to the server 2 at an arbitrary timing. Accordingly, it is possible to prevent the voting due to a faulty operation or the like, and it is also possible to deal with the change of the voting content. In this manner, the voter can perform desirable voting.

Further, as described above, as the backup of the voting by using the electronic data, the recording sheet on which the voting content is printed is created. However, the voting content before the change, which cannot receive the final approval by the voter, is affixed with the characters or the symbol indicating the meaning of denial, such as “x” or “NG”, so the voting content can be ignored at the time of manual summing up. On the other hand, the correct voting content which receives the final approval by the voter is affixed with the characters of the symbol indicating the positive meaning, such as “o” or “OK”, and the symbol such as the barcode indicating the voting content, so the manual or automatic summing up can be performed accurately. That is, on the recording sheet cut off to be the single-cut sheet, together with the voting content, the characters or the symbol indicating the approval or the disapproval of the voting content is written. Therefore, at the time of vote counting, it is necessary to confirm the characters or the symbol. By this operation, even in the case where the voting content is changed, erroneous summing up can be prevented.

Note that, in the structure as shown in FIG. 4, the recording head 9 and the cutter portion 11 come into remarkably close contact with each other. Therefore, without rewinding the fanfold sheet 16 after cutting, next printing can be started on the vicinity of the leading edge of the residual fanfold sheet 16 after cutting. Thus, little wasteful margin is caused. The portion on which the voting content of the preceding voter is printed is cut off by the cutter portion 11 and is discharged from the discharge port 15, so the each voter of the each recording sheet cannot be specified, and the recording sheet is not viewed by the next voter.

With this structure, by providing the window portion 12 of a sufficient size, printing the input content, and displaying the input content on an entire area of the window portion 12, it is possible to perform display which can be easily viewed by the voter in most cases in various elections. However, in a case where a rolled sheet is used as the recording sheet as in a conventional case, due to roll set, it is difficult to allow the rolled sheet having a free leading end to smoothly advance a long distance. In order to transport the rolled sheet while supporting the rolled sheet, a plurality of transport rollers have to be arranged in the window portion 12. As a result, a thickness of the window portion 12 increases thereby causing the printer 6 to be enlarged, and due to a mechanism for supplying a driving force to the transport rollers provided in the window portion 12, the structure becomes complicated. Further, in order to prevent the transport rollers provided in the window portion 12 from being obstacles to visual recognition of the portion of the recording sheet, on which the printing is performed, it is desired to arrange the transport rollers in positions avoiding a center of the window portion 12. Therefore, it is necessary to enlarge the casing 6a by the corresponding amount.

In contrast to this, in this embodiment, the fanfold sheet 16 is used as the recording sheet. The fanfold sheet 16 is stacked while being alternately folded for each predetermined length, and there is caused no roll set in the leading end portion of the sheet, which easily causes paper jam. Accordingly, even with the free leading end, it is easy for the fanfold sheet 16 to smoothly advance in the clearance 12c of the window portion 12, so there is no need for the conveying roller to be provided in the window portion 12. As a result, the enlargement and complication in the structure of the printer 6 can be prevented.

In this embodiment, the container 7 accommodating the fanfold sheet 16 is directly attached to the casing 6a of the printer 6. That is, the casing 6a and the container 7 can be integrally treated, that is, the printer 6 can be treated as one unit including the container 7 for the recording sheet. Therefore, the attachment and detachment with respect to the base surface 3a are easy. Accordingly, the one printer 6 can be mounted to various voting booths, and this structure is convenient for maintenance.

However, if the own weight of the fanfold sheet 16 is applied mainly to a bent end portion or an ultrathin side end surface, it is impossible to support the own weight, thereby causing the fanfold sheet 16 to be buckled or fallen in the accommodating portion 7a, leading to increase in transport load. As a result, even when the leading end side of the fanfold sheet 16 is pulled by the platen roller 10, the fanfold sheet 16 is not smoothly sent out in succession from the inside of the accommodating portion 7a. Therefore, there is a risk of failure in paper feeding. In contrast to this, in a case where the fanfold sheet 16 is arranged substantially horizontally such that a large-area flat surface (main surface) on which printing can be performed of the fanfold sheet 16 is substantially perpendicular to a direction of the gravity, the own weight of the fanfold sheet 16 can be supported by the large-area flat surface (main surface), thereby enabling the smooth transportation. However, in this case, a large space is required outside the casing 6a in the longitudinal direction of the fanfold sheet 16, thereby interrupting downsizing of the printer 6. Further, as shown in FIG. 2, in a case where the electronic voting device 1 including the base surface 3a and the container 7 is inclined in an angle adjustment range, there is a risk in that the own weight of the fanfold sheet 16 is applied not only to the large-area flat surface (main surface) but also to the bent end portion or the side end surface, thereby causing the buckling or falling, leading to increase in the transport load.

Here, in this embodiment, in the state where the container 7 is closed, the bottom surface 7b of the accommodating portion 7a is formed in the concave shape along the longitudinal direction of the fanfold sheet 16 accommodated in the accommodating portion 7a. This structure is provided for suppressing increase in the transport load of the fanfold sheet 16 due to its own weight in the accommodating portion 7a of the container 7. That is, according to the sheet retaining structure of this embodiment, the fanfold sheet 16 is retained on the concave bottom surface 7b of the closed container 7. At this time, the own weight of the fanfold sheet 16 is not applied to the folded end portion or the thin side end surface and is applied mainly to the large-area flat surface (main surface) on which printing can be performed. Therefore, the fanfold sheet 16 is supported without being bent or fallen due to its own weight in the container, so there is not caused the increase in transport load due to the own weight.

With the structure of this embodiment, the fanfold sheet 16 is retained while being bent substantially along a shape which is defined in advance along the concave bottom surface 7b. As shown in FIG. 2, the electronic voting device 1 including the base surface 3a and the container 7 is inclined within a predetermined angle adjustment range. However, even when the container 7 is inclined as described above, the fanfold sheet 16 is not bent in an unexpected shape or an irregular shape due to its own weight, further, the fanfold sheet 16 is not bent or fallen, and is constantly retained while being regularly bent substantially along the shape defined by the concave bottom surface 7b. Accordingly, there is not caused an unexpected too large transport load for the fanfold sheet 16, thereby making it possible to suppress the transport load within a range calculated in advance at a time of design. Further, with this structure, as shown in FIGS. 4 and 6, the fanfold sheet 16 in the stacked state where the fanfold sheet 16 is placed on the bottom surface 7b is bent inwardly at an upper layer portion as compared to a lower layer portion. Accordingly, even when an attitude of the container 7 fluctuates to some degree, the own weight of the fanfold sheet 16 is not applied to the upper layer portion thereof drawn out at a time of sheet feeding, so it is easy for the fanfold sheet 16 to be smoothly drawn out of the container 7. Further, there is exerted a force allowing the fanfold sheet 16, which is bent inwardly, to unfold outwardly so as to recover from the bent state, and a part of the force acts against the own weight, so the transport load due to the own weight of the fanfold sheet 16 is alleviated, and the fanfold sheet 16 can be fed relatively smoothly from beginning to end. Further, it is possible to constrain a space occupied by the container in the longitudinal direction of the fanfold sheet 16 to be small, so downsizing of the printer is not interfered to a large degree.

Further, the container 7 of this embodiment includes the main body portion 7d and a movable portion 7e which is connected to the main body portion 7d through the intermediation of the hinge mechanism 7c so as to be capable of opening and closing. Therefore, it is easy to set the fanfold sheet 16. That is, it is difficult to insert the fanfold sheet 16 formed in a bundle of a certain thickness into the accommodating portion 7a by deflecting to a large degree in the concave shape as shown in FIGS. 4 and 6 at the beginning. However, in this embodiment, as shown in FIGS. 7 and 8, the movable portion 7e can be opened with respect to the main body portion 7d. Accordingly, it suffices that, in this state where the container 7 is opened, the fanfold sheet 16 is inserted. At this time, as shown in FIG. 8, an amount of deflection of the fanfold sheet 16 is relatively small, so the fanfold sheet 16 can be inserted into the accommodating portion 7a by being deflected at an angle of about 90 degrees. After the fanfold sheet 16 is accommodated in the accommodating portion 7a, by closing the movable portion 7e with respect to the main body portion 7d as shown in FIG. 6, the bottom surface 7b of the accommodating portion 7a is formed in to the concave shape, thereby making it possible retain the fanfold sheet 16 with the fanfold sheet 16 being deflected to a large degree. After that, an uppermost portion of the fanfold sheet 16 may be drawn out and inserted into the casing 6a to be set therein.

As described above, according to this embodiment, as shown in FIG. 8, by inserting the fanfold sheet 16 into the accommodating portion 7a of the container 7 while being deflected to a small degree, and then swinging the movable portion 7e of the container 7 to close, as shown in FIGS. 4 and 6, the fanfold sheet 16 can be retained while being deflected in a U-shape. This remarkably facilitates the operation as compared to a case where the fanfold sheet 16 is deflected in the U-shape in a completely free state.

As described above, in this embodiment, by using the fanfold sheet 16 and making the bottom surface 7b of the container 7 for accommodating the fanfold sheet 16 in the concave shape, the recording sheet can be smoothly transported. Further, setting of the fanfold sheet 16 into the container 7 is extremely easy.

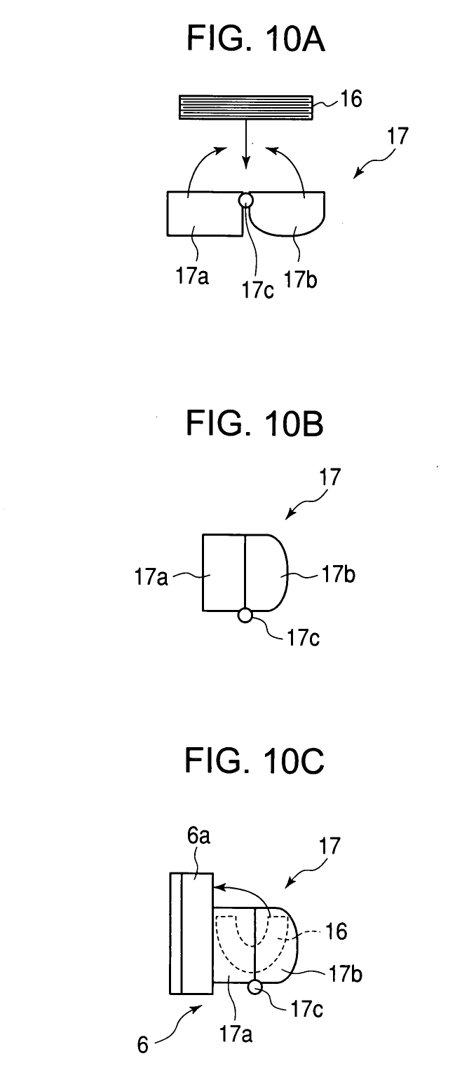

Next, a description will be made of the other embodiments of the present invention schematically shown in FIGS. 10A-10C to 12A-12C. A container 17 according to a second embodiment of the present invention shown in FIGS. 10A-10C includes a pair of movable portions 17a and 17b connected to each other through intermediation of a hinge mechanism 17c so as to be capable of opening and closing. Accordingly, as shown in FIG. 10A, the fanfold sheet 16 in a substantially flat state can be inserted in a state where the pair of movable portions 17a and 17b are opened with respect to each other. Next, as shown in FIG. 10B, by realizing a state where the movable portions 17a and 17b are closed with respect to each other, the fanfold sheet 16 can be retained while being deflected in the U-shape. After that, as shown in FIG. 10C, one movable portion 17a of the movable portions may be attached to the casing 6a, and the uppermost portion of the fanfold sheet 16 may be drawn out and inserted into the casing 6a to be set therein. With this structure, at the time of inserting the fanfold sheet 16, the container 7 can be detached from the casing 6a, so the operation is easier.

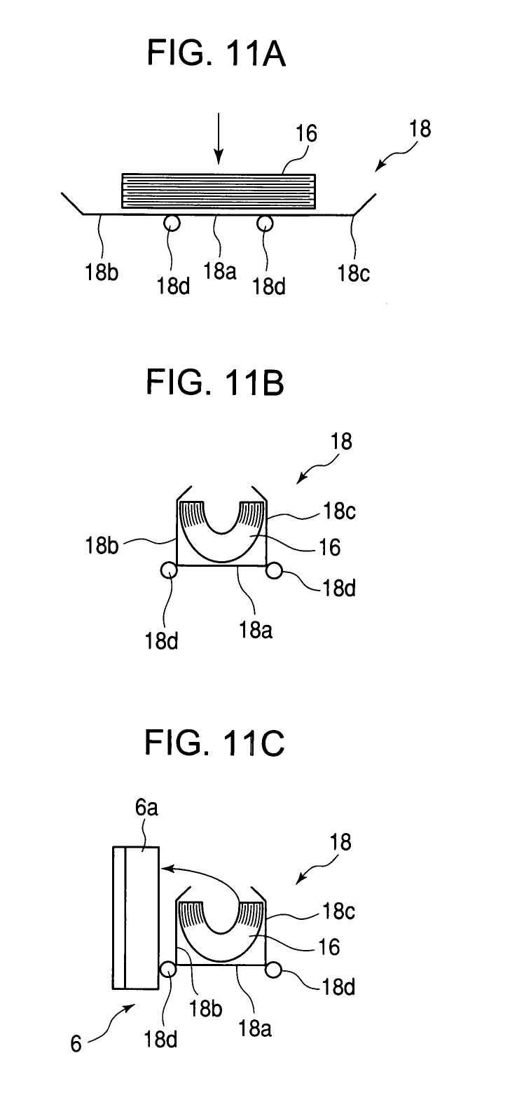

A container 18 according to a third embodiment of the present invention shown in FIGS. 11A-11C has a structure in which to both sides of a main body portion 18a, movable portions 18b and 18c are connected through intermediation of each of hinge mechanisms 18d. As shown in FIG. 11A, in a state where the movable portions 18b and 18c are opened with respect to the main body portion 18a, the fanfold sheet 16 in the substantially flat state can be inserted. After that, as shown in FIG. 11B, by closing the movable portions 18b and 18c with respect to the main body portion 18a, the fanfold sheet 16 can be retained while being deflected in the U-shape. In this manner, in a state where the fanfold sheet 16 is retained in the container 18 while being deflected in the U-shape, as shown in FIG. 11C, the movable portion 18b may be attached to the casing 6a, and the uppermost portion of the fanfold sheet 16 is drawn out and inserted into the casing 6a to be set therein. With this structure, at the time of inserting the fanfold sheet 16, the container 7 can be detached from the casing 6a, so the operation is easier, and the operation at the time of inserting the fanfold sheet 16 is easier.

Note that, in the second and third embodiments as shown in FIGS. 10A-10C and 11A-11C, respectively, there can also be adopted, instead of the structure in which the movable portion 17a, 18b is attached to the casing 6a, a structure in which the container 17 and 18 are placed on a floor surface without being mounted onto the casing 6a. In this case, a relatively large amount of the fanfold sheet 16 can be retained, and a load applied to the casing 6a can be reduced.

The containers 7, 17, and 18 described above each have a structure including two or more portions connected to each other through the hinge mechanism. However, the number of portions connected through the hinge mechanism is not limited to two or three, four or more portions may be connected to each other.

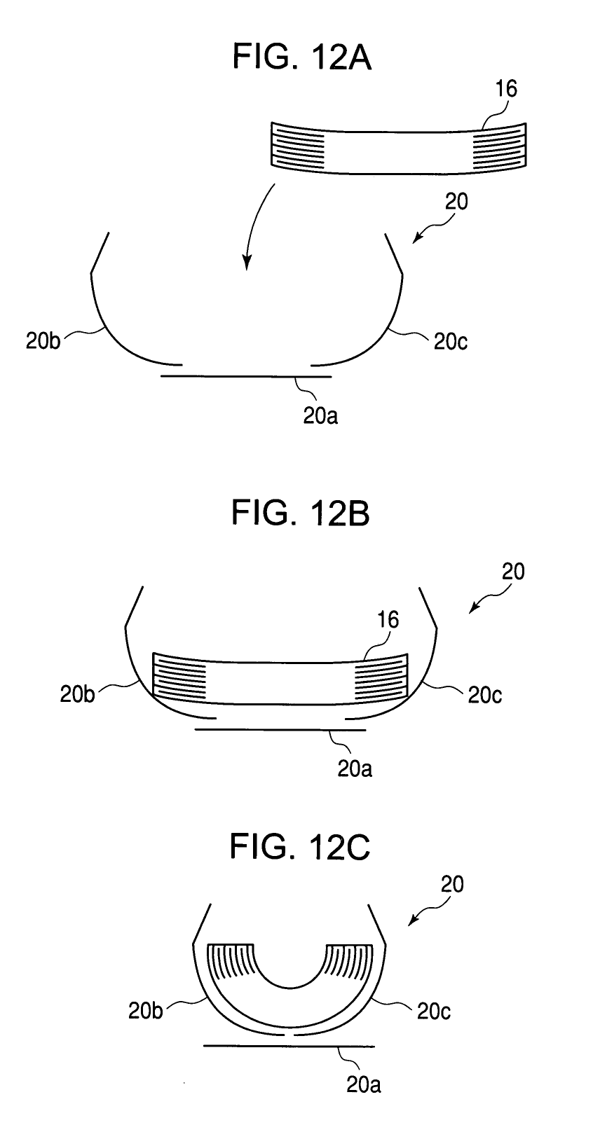

Further, the mechanism for connecting the plurality of portions of the container to each other is not limited to the hinge mechanism as described above. For example, as in a fourth embodiment of the present invention schematically shown in FIGS. 12A-12C, it is possible to use a container 20 having a structure in which, on both sides of a guide portion 20a, movable portions 20b and 20c are slidably connected to each other. In this case, as show in FIGS. 12A and 12B, in a state where the movable portions 20b and 20c are spaced apart from each other, that is, the container 20 is opened, the fanfold sheet 16 in the substantially flat state can be inserted. After that, as shown in FIG. 12C, the movable portions 20b and 20c are allowed to slide to be closer to each other, thereby making the container 20 be in the closed state, and the fanfold sheet 16 is retained while being deflected in the U-shape. With this structure also, substantially the same effect can be obtained as that of the second and third embodiments. Note that, also in the fourth embodiment, the container may be directly mounted onto the casing 6, or the container 20 may be placed on the floor surface without mounting onto the casing 6a.

What is claimed is:

1. A sheet retaining structure, comprising a container for retaining a fanfold sheet stacked by alternately folding for a predetermined length, and supplying the fanfold sheet to a casing of a printer, wherein:
the container includes a plurality of portions connected to each other so as to be opened and closed with respect to each other; and
when the plurality of portions are in an opened state with respect to each other, the fanfold sheet can be inserted into the container, and when the plurality of portions are in a closed state with respect to each other, the plurality of portions form a concave shape extending along a longitudinal direction of the fanfold sheet, and the container can retain the fanfold sheet along the concave shape of the container in a state where the fanfold sheet is deflected to a larger degree than when in the opened state.

2. A sheet retaining structure according to claim 1, wherein the plurality of portions are connected to each other so that the plurality of portions can be opened and closed with respect to each other through a hinge mechanism.

3. A sheet retaining structure according to claim 1, wherein the fanfold sheet is retained while being deflected in a U-shape in the container in the closed state.

4. A sheet retaining structure according to claim 1, wherein one of the plurality of portions comprises a main body portion which can be mounted onto the casing, and another portion comprises a movable portion which can be opened and closed with respect to the main body portion.

5. A printer for an electronic voting device, comprising:
the sheet retaining structure according to claim 1;
a printing portion, arranged in the casing, for performing printing on a part of the fanfold sheet supplied from the container;
a cutter portion, arranged in the casing, for cutting off the part of the fanfold sheet, on which the printing is performed by the printing portion;
a window portion, provided to a portion of the casing on a downstream side of the printing portion with respect to an advancing direction of the fanfold sheet, for allowing visual recognition of the part, on which the printing is performed, from an outside; and
a discharge port, provided to a portion of the casing on the downstream side of the window portion with respect to the advancing direction of the fanfold sheet, for discharging the portion on which the printing is performed and which is cut off by the cutter portion.
